(19) United States
(12) Patent Application Publication
(10) Pub. No.: US 2006/0203818 A1
(43) Pub. Date: Sep. 14, 2006

(54) METHOD FOR MULTICAST PACKET FORWARDING IN A SWITCH

(76) Inventors: Jin-Ru Chen, Tai-Chung City (TW); Yi-Lun Chen, Chang-Hua Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,301

(22) Filed: Dec. 22, 2005

(30) Foreign Application Priority Data
Dec. 24, 2004 (TW) 093140608

(51) Int. Cl. H04L 12/56

(52) U.S. Cl. 370/390

(57) ABSTRACT

A method for multicast packet forwarding in a switch. The switch includes a look-up table and a plurality of ports. The switch transfers a multicast packet according to the look-up table. The method includes receiving the multicast packet from a port; if the multicast packet conforms to a specific transmission protocol then detecting a destination address information in the multicast packet; and checking whether the destination address information belongs to a network address set, wherein if the destination address information belongs to the network set the port is determined to be coupled to a multicast packet processing device and a corresponding relationship between the port and the multicast packet processing device is stored into the look-up table.

### BACKGROUND OF THE INVENTION

1. Field of the Invention

The invention relates to network communications, and more particularly, to network switch devices.

2. Description of the Prior Art

There are three types of packets for use in Internet communications. They are broadcast packets, multicast packets, and unicast packets. The unicast packet is a point-to-point packet. That is, the unicast packet is transferred from a source network device to a destination network device. The broadcast packet is forwarded to all output ports regardless of the source of the broadcast packet. The multicast packet is the most complex because it is forwarded from a source to multiple specific destination devices, wherein the destination devices' addresses are grouped in the same group with a group address.

More specifically, there are two types of multicast packets, IGMP control protocol packets and IP multicast data packets. A switch processes the above-mentioned two types of multicast packets using different procedures. The IGMP control protocol packet can be further divided into two types. The first type of IGMP control protocol packet is a router protocol packet. An IGMP query packet is an example of a router protocol packet. These packets are transferred from a router. The second type of IGMP control protocol packet is a group member protocol packet. An IGMP report packet and an IGMP leave packet are examples of group member protocol packets. Generally speaking, the router protocol packet is transferred to all output ports in a broadcast manner; while the IP multicast data packet is transferred according to a look-up table in the switch. If the look-up table has already stored corresponding relationships between the destination addresses and the group members, then the IP multicast data packet is transferred to corresponding output ports and router ports of the switch. If corresponding address relationships are not stored, then the IP multicast data packet is broadcast to all output ports of the switch.

When a host first joins an IP multicast group, the above-mentioned IGMP report packet is generated. After the switch receives the IGMP report packet, the relationship between the connecting port and the host, which is now a multicast group member, is established. Furthermore, a multicast router maintains and updates the group member information by periodically sending the above-mentioned IGMP query packet to all the hosts. The switch can at the same time store relationships between the connecting port and the multicast router when receiving the IGMP query packet; however, not all switches have the above-mentioned learning ability (i.e., snooping capability). For example, when the multicast packet is transferred to a switch that does not have the snooping capability, the switch must broadcast the multicast packet to all connecting ports because it did not learn specifically where to transfer the packet. Obviously, this burdens network bandwidth.

In the application of switches nowadays, a central processing unit (CPU) or an application specific integrated circuit (ASIC) is utilized to process the transmission of the multicast packet. Unfortunately, the CPU increases the hardware's complexity and the ASIC does not provide flexibility. For example, a length of an IP header of a normal packet is 20-bytes; therefore, the ASIC is usually designed to read the 20-byte IP header. But the IP header usually has additional IP options, and as a result, the embedded ASIC cannot correctly read the IP header with IP options. Additionally, the ASIC cannot correctly read upper-layer information (e.g., the IGMP header) of the packet. Therefore, the ASIC within the switch cannot know the source switch of the multicast packet and cannot smoothly complete the snooping.

### SUMMARY OF THE INVENTION

It is therefore one of the objectives of the claimed invention to provide a method of utilizing information about a destination address to transfer a multicast packet.

According to an exemplary embodiment of the claimed invention, a method for forwarding a multicast packet, the method being utilized in a switch, the switch comprises a look-up table and a plurality of connecting ports; the switch forwards the multicast packet according to the look-up table. The method comprises: receiving the multicast packet from one of the connecting ports; if the multicast packet complies with a certain communication protocol then detecting the destination address information of the multicast packet; and detecting whether the destination address information complies with a network address set, and if the destination address information complies with network address set, determining that the connecting port is coupled to a multicast packet processing device and storing the relationship between the connecting port and the multicast packet processing device in the look-up table.

A method for forwarding a multicast packet, the method being utilized in a switch, the switch comprises a look-up table and a plurality of connecting ports, the switch forwards the multicast packet according to the look-up table, and the method comprises: receiving the multicast packet from a connecting port; if the multicast packet complies with an IGMP_{V3} communication protocol, detecting a packet type of the multicast packet, and if the packet type complies with a packet type set, determining that the connecting port is coupled to a multicast packet processing device and storing a relationship between the connecting port and the multicast packet processing device in the look-up table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a method for transferring a multicast packet according to a first embodiment of the present invention.

FIG. 2 is a diagram of a method of transferring a multicast packet complying with an IGMP_{V3} communication protocol according to a second embodiment of the present invention.

FIG. 3 is a diagram of a method for transferring a multicast packet according to a third embodiment of the present invention.

FIG. 4 is a diagram of a method of transferring a multicast packet complying with an IGMP_{V3} communication protocol according to a fourth embodiment of the present invention.

FIG. 5 is a diagram of a method of transferring a multicast packet complying with an IGMP_{V3} communication protocol according to a fifth embodiment of the present invention.

### DETAILED DESCRIPTION

For easy illustration, in the following embodiments, all packets transmitted comply with IGMP communication protocol; however, the IGMP communication protocol is utilized herein merely as an example and is not meant to serve as limitation. For example, replacing the original snooping method that utilizes upper-layer information with a snooping method that utilizes lower-layer (layer 2 or layer 3) information conforming to the spirit of the present invention still falls within the scope of the invention.

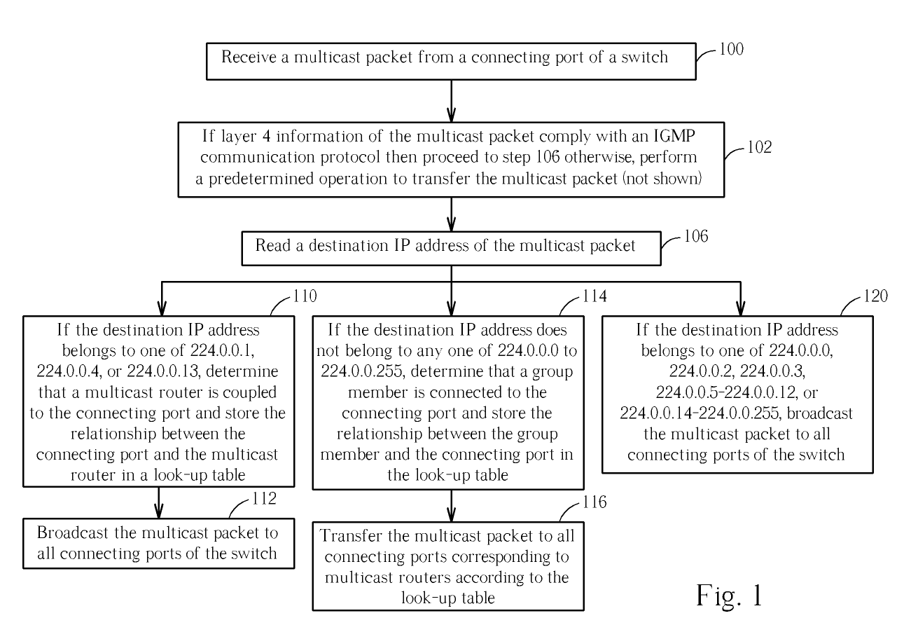

Please refer to FIG. 1, which is a diagram of a method for transferring a multicast packet according to a first embodiment of the present invention. The method comprises the following steps:

Step 100: Receive a multicast packet from a connecting port of a switch;

Step 102: If layer 4 information of the multicast packet comply with an IGMP communication protocol, then proceed to step 106; otherwise, perform a predetermined operation to transfer the multicast packet (not shown);

Step 106: Read a destination IP address of the multicast packet;

Step 110: If the destination IP address belongs to one of 224.0.0.1, 224.0.0.4, or 224.0.0.13, determine that a multicast router is coupled to the connecting port and store the relationship between the connecting port and the multicast router in a look-up table;

Step 112: Broadcast the multicast packet to all connecting ports of the switch;

Step 114: If the destination IP address does not belong to any one of 224.0.0.0 to 224.0.0.255, determine that a group member is connected to the connecting port and store the relationship between the group member and the connecting port in the look-up table;

Step 116: Transfer the multicast packet to all connecting ports corresponding to multicast routers according to the look-up table; and

Step 120: If the destination IP address belongs to one of 224.0.0.0, 224.0.0.2, 224.0.0.3, 224.0.0.5-224.0.0.12, or 224.0.0.14-224.0.0.255, broadcast the multicast packet to all connecting ports of the switch.

Upon first receiving a packet from a connecting port, the switch does not know the source of the packet or if the packet is a multicast packet. As a result, the switch performs numerous examining operations to determine whether the packet is a multicast packet (step 100). As is known by those skilled in the art, the switch can begin by examining some of the significant bits of a destination media access control (DMAC) address to determine whether it complies with a multicast packet standard. For example, if the packet is a multicast packet, then the most significant bits of the above-mentioned DMAC address are 01005e₍₁₆₎. If the DMAC address does not comply with the multicast packet standard, then the packet can be a unicast packet or a broadcast packet. The processing method for both broadcast and unicast packets are well known, and are thus omitted herein.

Next, the switch detects whether the multicast packet complies with the IGMP communication protocol (step 102). That is, the switch detects the IP header of the multicast packet. As is known by those skilled in the art, the IP header of the multicast packet contains a field for storing the layer 4 communication protocol of the packet. Please note that if the packet utilizes the IGMP communication protocol, then step 106 is performed. For example, if the packet utilizes the UDP communication protocol, then the packet is a data packet that needs to be transferred to a member of the member group. Therefore, the predetermined operation is to check the switch's look-up table to ensure the transfer the packet to the correct connecting port so that the correct group member can receive the packet.

On the other hand, if the multicast packet complies with the IGMP communication protocol, the switch reads the destination IP address (step 106) of the IP header and learns the device connected to the connecting port based on the destination IP address. As is known by those skilled in the art, if the destination IP belongs to one of 224.0.0.1, 224.0.0.4, or 224.0.0.13, then the multicast packet was transferred from a multicast router. Therefore, the switch stores the relationship between the connecting port and the multicast router in the above-mentioned look-up table (step 110) and broadcasts the multicast packet to all connecting ports (step 112) of the switch. For example, if the multicast packet is the aforementioned query packet, the destination IP address of the multicast packet is 224.0.0.1.

Furthermore, if the destination IP address does not belong any one of 224.0.0.0-224.0.0.255, this indicates that the multicast packet may be an IGMP_{V1} report packet, an IGMP_{V2} report packet, or a leave packet from a group member. Therefore, the switch determines that the device connected to the connecting port is a group member and stores the corresponding relationship between the group member and the connecting port in the look-up table (step 114). Finally, the switch transfers the multicast packet to all connecting ports corresponding to multicast routers.

In addition, if the destination IP address belongs to 224.0.0.0, 224.0.0.2, 224.0.0.3, 224.0.0.5-224.0.0.12, or 224.0.0.14-224.0.0.255, then the IP address is reserved for router protocols. Therefore, the switch will only broadcast the multicast packet to all connecting ports without adding or updating a record in the look-up table (step 120).

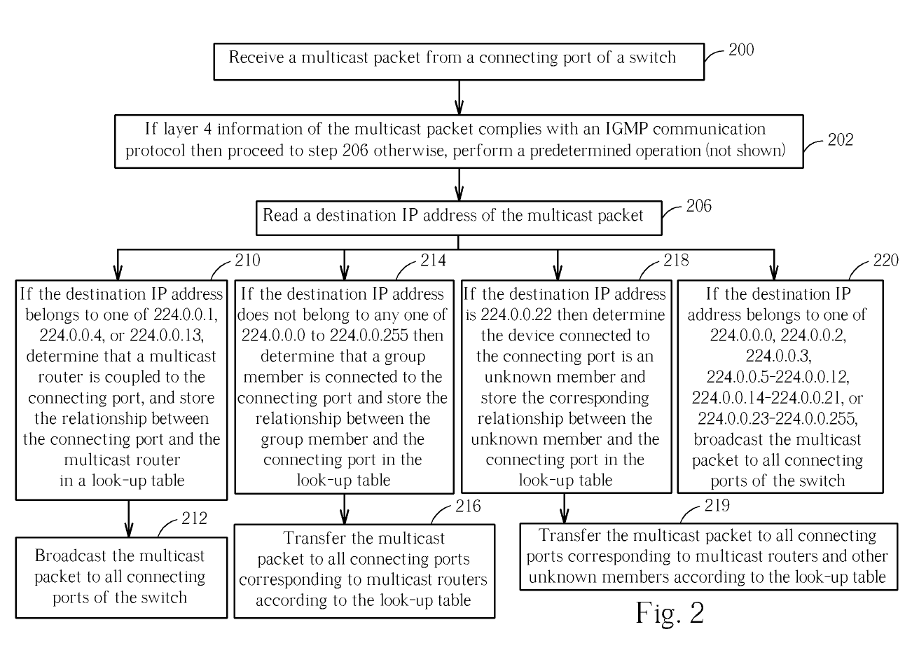

Please refer to FIG. 2, which is a method for transferring a multicast packet complying with IGMP_{V3} according to a second embodiment of the present invention. In this embodiment, the method comprises following steps:

Step 200: Receive a multicast packet from a connecting port of a switch;

Step 202: If layer 4 information of the multicast packet complies with an IGMP communication protocol, then proceed to step 206; otherwise, perform a predetermined operation (not shown);

Step 206: Read a destination IP address of the multicast packet;

Step 210: If the destination IP address belongs to one of 224.0.0.1, 224.0.0.4, or 224.0.0.13, determine that a multicast router is coupled to the connecting port, and store the relationship between the connecting port and the multicast router in a look-up table;

Step 212: Broadcast the multicast packet to all connecting ports of the switch;

Step 214: If the destination IP address does not belong to any one of 224.0.0.0 to 224.0.0.255, then determine that a group member is connected to the connecting port and store the relationship between the group member and the connecting port in the look-up table;

Step 216: Transfer the multicast packet to all connecting ports corresponding to multicast routers according to the look-up table;

Step 218: If the destination IP address is 224.0.0.22, then determine the device connected to the connecting port is an unknown member and store the corresponding relationship between the unknown member and the connecting port in the look-up table;

Step 219: Transfer the multicast packet to all connecting ports corresponding to multicast routers and other unknown members according to the look-up table; and

Step 220: If the destination IP address belongs to one of 224.0.0.0, 224.0.0.2, 224.0.0.3, 224.0.0.5-224.0.0.12, 224.0.0.14-224.0.0.21, or 224.0.0.23-224.0.0.255, broadcast the multicast packet to all connecting ports of the switch.

Please note that step 200 through step 216 are all the same as step 100 through step 116 and that for simplicity the related operations are omitted hereinafter. In this embodiment, because the contents of the IGMP_{V3} communication protocol are far more than the contents of IGMP_{V1} or IGMP_{V2}, the multicast packet complying with IGMP_{V3} communication protocol comprises more information related to multicast group. As shown in FIG. 2, the steps 218 and 219 are utilized for the IGMP_{V3} communication protocol. When the destination IP address of the multicast packet is 224.0.0.22, this indicates that the multicast packet comes from a specific member of the IGMP_{V3} communication protocol. In this embodiment, the specific member is regarded as an unknown member. In other words, the unknown member is not the above-mentioned multicast router or the group member. Therefore, utilizing step 218, the switch determines that the device connected to the connecting port is an unknown member and stores the corresponding relationship between the connecting port and the unknown member in the look-up table. Finally, the switch transfers the multicast packet to all connecting ports corresponding to multicast routers and other unknown members according to the look-up table (step 219).

Furthermore, step 220 is also designed to comply with the IGMP_{V3} communication protocol. In this embodiment, if the destination IP address of the multicast packet is 224.0.0.22, the switch determines that the multicast packet is from an unknown member. Obviously, the determination mechanism of step 220 is different from that of step 120; therefore, the IP address 224.0.0.2 is removed in step 220.

Please note that this embodiment collects all uncertain connecting ports (i.e., the switch does not exactly know the device connected to the connecting port) as unknown member ports. The switch regards these unknown members as not supporting multicast packet forwarding. Unfortunately this causes a problem. For example, if all connecting ports are all connected to devices complying with the IGMP_{V3} communication protocol and because all devices may send packets with the destination IP address 224.0.0.22, all connecting ports will be regarded as unknown member ports. This will disable the above-mention snooping capability of the switch. In other words, the switch cannot further distinguish that the unknown member belongs to the multicast router or to the group member. When a multicast packet is transferred to a specific group member the switch in effect broadcasts the multicast packet because the switch thinks all connecting ports are unknown member ports. Therefore, in this embodiment, we have another mechanism to avoid above-mentioned problem. That is, if the unknown member port continues to not receive a multicast packet complying with the IGMP_{V3} communication protocol for a predetermined period, the switch deletes the corresponding relationship between the connecting port and the unknown member from the look-up table. Therefore, the above-mentioned problem can be avoided.

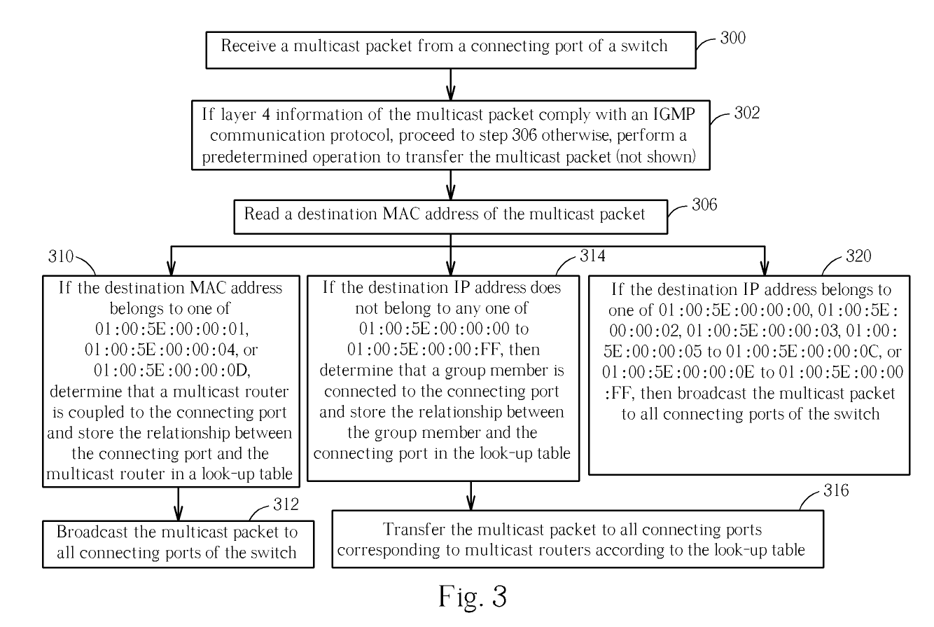

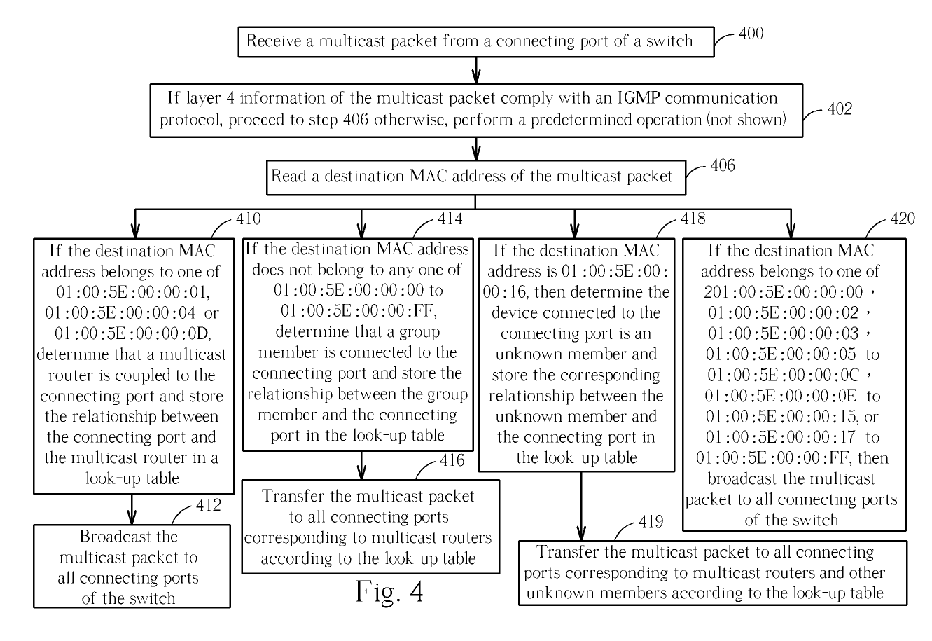

Please note that it is well known that the destination IP address and the destination MAC address have a corresponding relationship. Therefore, the present invention method can also be implemented utilizing the destination MAC address instead of destination IP address. The related flow chart can be referred to FIG. 3 and FIG. 4. FIG. 3 is a diagram of a method for transferring a multicast packet according to a third embodiment of the present invention. In this embodiment, the method comprises the following steps:

Step 300: Receive a multicast packet from a connecting port of a switch;

Step 302: If layer 4 information of the multicast packet comply with an IGMP communication protocol, proceed to step 306; otherwise, perform a predetermined operation to transfer the multicast packet (not shown);

Step 306: Read a destination MAC address of the multicast packet;

Step 310: If the destination MAC address belongs to one of 01:00:5E:00:00:01, 01:00:5E:00:00:04, or 01:00:5E:00:00:0D, determine that a multicast router is coupled to the connecting port and store the relationship between the connecting port and the multicast router in a look-up table;

Step 312: Broadcast the multicast packet to all connecting ports of the switch;

Step 314: If the destination IP address does not belong to any one of 01:00:5E:00:00:00 to 01:00:5E:00:00:FF, then determine that a group member is connected to the connecting port and store the relationship between the group member and the connecting port in the look-up table;

Step 316: Transfer the multicast packet to all connecting ports corresponding to multicast routers according to the look-up table; and

Step 320: If the destination IP address belongs to one of 01:00:5E:00:00:00, 01:00:5E:00:00:02, 01:00:5E:00:00:03, 01:00:5E:00:00:05 to 01:00:5E:00:00:0C, or 01:00:5E:00:00:0E to 01:00:5E:00:00:FF, then broadcast the multicast packet to all connecting ports of the switch.

Additionally, FIG. 4 is a method for transferring a multicast packet complying with the IGMP_{V3} communication protocol according to a fourth embodiment of the present invention. In this embodiment, the method comprises the following steps:

Step 400: Receive a multicast packet from a connecting port of a switch;

Step 402: If layer 4 information of the multicast packet comply with an IGMP communication protocol, proceed to step 406; otherwise, perform a predetermined operation (not shown);

Step 406: Read a destination MAC address of the multicast packet;

Step 410: If the destination MAC address belongs to one of 01:00:5E:00:00:01, 01:00:5E:00:00:04, or 01:00:5E:00:00:0D, determine that a multicast router is coupled to the connecting port and store the relationship between the connecting port and the multicast router in a look-up table;

Step 412: Broadcast the multicast packet to all connecting ports of the switch;

Step 414: If the destination MAC address does not belong to any one of 01:00:5E:00:00:00 to 01:00:5E:00:00:FF, determine that a group member is connected to the connecting port and store the relationship between the group member and the connecting port in the look-up table;

Step 416: Transfer the multicast packet to all connecting ports corresponding to multicast routers according to the look-up table;

Step 418: If the destination MAC address is 01:00:5E:00:00:16, then determine the device connected to the connecting port is an unknown member and store the corresponding relationship between the unknown member and the connecting port in the look-up table;

Step 419: Transfer the multicast packet to all connecting ports corresponding to multicast routers and other unknown members according to the look-up table; and

Step 420: If the destination MAC address belongs to one of 201:00:5E:00:00:00, 01:00:5E:00:00:02, 01:00:5E:00:00:03, 01:00:5E:00:00:05 to 01:00:5E:00:00:0C, 01:00:5E:00:00:0E to 01:00:5E:00:00:15, or 01:00:5E:00:00:17 to 01:00:5E:00:00:FF, then broadcast the multicast packet to all connecting ports of the switch.

Utilizing the destination MAC address is quite similar to utilizing the destination IP address. Those skilled in the art can easily understand the operation flow of FIG. 3 and FIG. 4 thus the operation is omitted herein.

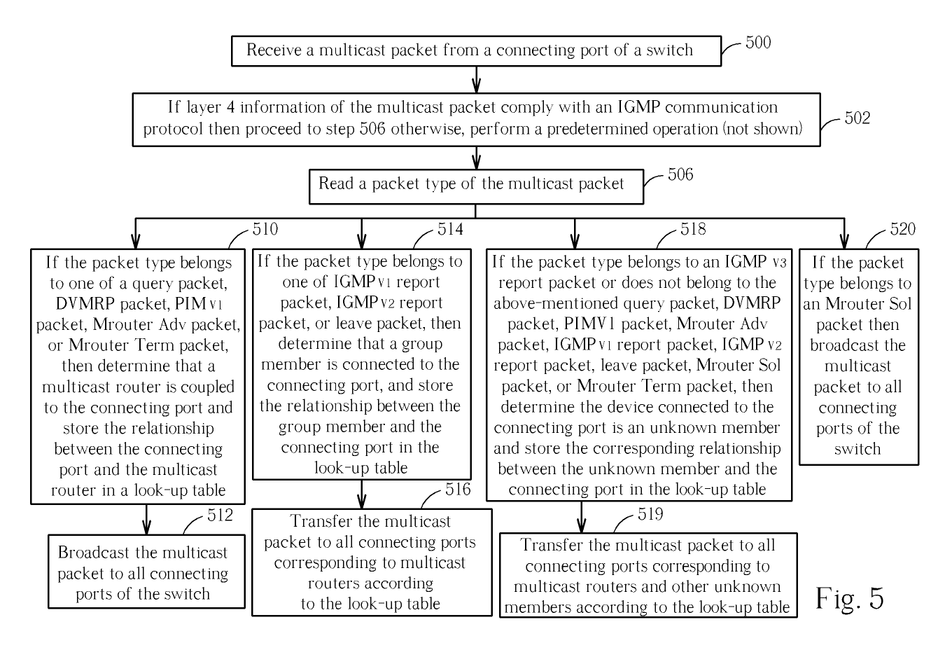

Surely, the present invention can directly obtain the packet type from the layer 4 (IGMP) information and perform a corresponding operation. Please refer to FIG. 5, which is a method for transferring a multicast packet complying with IGMP_{V3} communication protocol according to a fifth embodiment of the present invention. The method comprises following steps:

Step 500: Receive a multicast packet from a connecting port of a switch;

Step 502: If layer 4 information of the multicast packet comply with an IGMP communication protocol then proceed to step 506; otherwise, perform a predetermined operation (not shown);

Step 506: Read a packet type of the multicast packet;

Step 510: If the packet type belongs to one of a query packet, DVMRP packet, PIM_{V1} packet, Mrouter Adv packet, or Mrouter Term packet, then determine that a multicast router is coupled to the connecting port and store the relationship between the connecting port and the multicast router in a look-up table;

Step 512: Broadcast the multicast packet to all connecting ports of the switch;

Step 514: If the packet type belongs to one of IGMP_{V1} report packet, IGMP_{V2} report packet, or leave packet, then determine that a group member is connected to the connecting port, and store the relationship between the group member and the connecting port in the look-up table;

Step 516: Transfer the multicast packet to all connecting ports corresponding to multicast routers according to the look-up table;

Step 518: If the packet type belongs to an IGMP_{V3} report packet or does not belong to the above-mentioned query packet, DVMRP packet, PIM_{V1} packet, Mrouter Adv packet, IGMP_{V1} report packet, IGMP_{V2} report packet, leave packet, Mrouter Sol packet, or Mrouter Term packet, then determine the device connected to the connecting port is an unknown member and store the corresponding relationship between the unknown member and the connecting port in the look-up table;

Step 519: Transfer the multicast packet to all connecting ports corresponding to multicast routers and other unknown members according to the look-up table; and

Step 520: If the packet type belongs to an Mrouter Sol packet then broadcast the multicast packet to all connecting ports of the switch.

Utilizing the packet type to determine the source of the multicast packet is well known. Here, the above-mentioned operation shown in FIG. 5 is related to the IGMP_{V3} communication protocol (the unknown member is added). Additionally, the definition and the operation of the unknown member are already illustrated in the above disclosure and thus omitted here.

The present invention method in the embodiment described above can utilize the layer 2 destination MAC address information or layer 3 destination IP address information to obtain the packet type of a multicast packet allowing the switch to know the source of the multicast packet and correctly complete snooping. Therefore, the data packet can be forwarded more efficiently and the prior art problem of incorrectly reading the IP option of the IP header is solved. Furthermore, the present invention adds a new member, the unknown member, for the IGMPV3 communication protocol so that snooping and packet transmission are more efficient.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for forwarding a multicast packet, the method being utilized in a switch, the switch comprising a look-up table and a plurality of connecting ports; the switch forwarding the multicast packet according to the look-up table, the method comprising:
receiving the multicast packet from one of the connecting ports;
if the multicast packet complies with a certain communication protocol then detecting the destination address information of the multicast packet; and
detecting whether the destination address information complies with a network address set and if the destination address information complies with network address set then further determining that the connecting port is coupled to a multicast packet processing device and storing the relationship between the connecting port and the multicast packet processing device in the look-up table.

2. The method of claim 1, wherein the communication protocol is an IGMP communication protocol.

3. The method of claim 2, wherein the multicast packet processing device is a multicast router.

4. The method of claim 3, wherein the destination address information is a destination IP address and the network address set comprises 224.0.0.1, 224.0.0.4, and 224.0.0.13.

5. The method of claim 3, wherein the destination address information is a destination MAC address, and the network address set comprises 01:00:5E:00:00:01, 01:00:5E:00:00:04, and 01:00:5E:00:00:0D.

6. The method of claim 2, wherein the multicast processing device is a multicast group member.

7. The method of claim 6, wherein the destination address information is a destination IP address, and the network address set does not comprise any one of 224.0.0.0 to 224.0.0.255.

8. The method of claim 6, wherein the destination address information is a destination MAC address and the network address set does not comprise any one of 01:00:5E:00:00:00 to 01:00:5E:00:00:FF.

9. The method of claim 2, wherein the step of detecting whether the destination address information complies with the network address set further comprises:
if the destination address information does not comply with the network address set then broadcasting the multicast packet to a plurality of connecting ports of the connecting ports of the switch.

10. The method of claim 2, wherein the IGMP communication protocol is an IGMP_{V3} communication protocol.

11. The method of claim 10, wherein the multicast packet processing device is an unknown member.

12. The method of claim 10, wherein the destination address information is a destination IP address and the network address set comprises 224.0.0.22.

13. The method of claim 10, wherein the destination address information is a destination MAC address and the network address set comprises 01:00:5E:00:00:16.

14. A method for forwarding a multicast packet, the method being utilized in a switch, the switch comprising a look-up table and a plurality of connecting ports, the switch forwarding the multicast packet according to the look-up table, the method comprising:
receiving the multicast packet from a connecting port;
if the multicast packet complies with an IGMP_{V3} communication protocol then detecting a packet type of the multicast packet and if the packet type complies with a packet type set then further determining that the connecting port is coupled to a multicast packet processing device and storing a relationship between the connecting port and the multicast packet processing device in the look-up table.

15. The method of claim 14, wherein the multicast packet processing device is a multicast router.

16. The method of claim 15 further comprising:
broadcasting the multicast packet to a plurality of connecting ports of the connecting ports of the switch.

17. The method of claim 14, wherein the multicast packet processing device is a multicast group member.

18. The method of claim 17, wherein another connecting port of the switch is coupled to a multicast router, and the method further comprises:
forwarding the multicast packet to the multicast router.

19. The method of claim 14, wherein the multicast packet processing device is an unknown member.

20. The method of claim 19, wherein another connecting port of the switch is coupled to a multicast router, another connecting port is coupled to another unknown member and the method further comprises:
forwarding the multicast packet to the multicast router and another unknown member.
